(19) United States
(12) Patent Application Publication
(10) Pub. No.: US 2026/0277433 A1
(43) Pub. Date: Sep. 17, 2026

(54) ENABLING WEAK MEMORY DIES TO MEET PRODUCT REQUIREMENTS

(71) Applicant: Micron Technology, Inc., Boise, ID (US)

(72) Inventors: Ying Yu Tai, Mountain View, CA (US); Jun Wan, San Jose, CA (US); Seungjune Jeon, Santa Clara, CA (US); Wei Wang, Fremont, CA (US); Zhenming Zhou, San Jose, CA (US)

(21) Appl. No.: 19/077,922

(22) Filed: Mar. 12, 2025

(51) Int. Cl. G06F 3/06

(52) U.S. Cl. CPC G06F 3/0604; G06F 3/0659; G06F 3/0679

(57) ABSTRACT

A processing device in a memory sub-system initiates a plurality of write operations on a plurality of memory devices based on received write commands, the plurality of memory devices including at least one memory device having lower endurance characteristics than a remainder of the plurality of memory devices, and the plurality of write operations utilizing a host write cursor and a media management write cursor. The processing device permits the host write cursor to utilize segments on any of the plurality of memory devices including the at least one memory device having the lower endurance characteristics and prevents the media management write cursor from utilizing the at least one memory device having the lower endurance characteristics for at least a subset of the plurality of write operations.

### TECHNICAL FIELD

Embodiments of the disclosure relate generally to memory sub-systems, and more specifically, relate to enabling weak memory dies to meet product requirements in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 is a flow diagram of an example method of enabling weak memory dies to meet product requirements in accordance with some embodiments of the present disclosure.

FIG. 3 is a block diagram illustrating the use of weak memory dies in a memory sub-system in accordance with some embodiments of the present disclosure.

FIG. 4 is a flow diagram of an example method of enabling a memory die with weak pages to meet product requirements in accordance with some embodiments of the present disclosure.

FIG. 5 is a block diagram illustrating the use of a memory die with weak pages in a memory sub-system in accordance with some embodiments of the present disclosure.

FIG. 6 is a block diagram of an example computer system in which embodiments of the present disclosure may operate.

### DETAILED DESCRIPTION

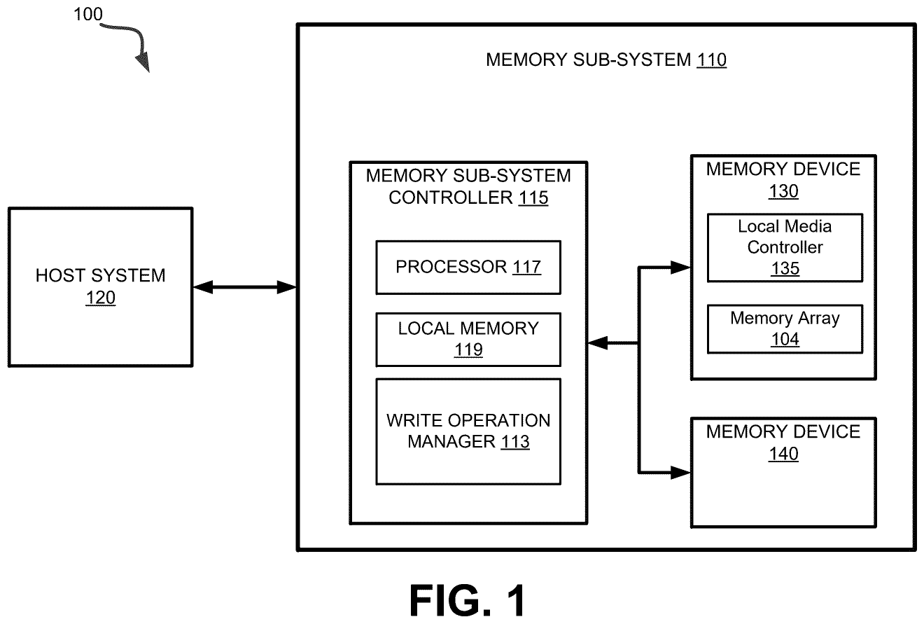

Aspects of the present disclosure are directed to enabling weak memory dies to meet product requirements in a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more dies, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

One example of a memory sub-system is a solid-state drive (SSD) that includes one or more non-volatile memory devices (e.g., memory dies) and a memory sub-system controller to manage the non-volatile memory devices. The memory sub-systems can ultimately be sold to a variety of different customers and/or be intended for implementation in a variety of different uses cases. For example, some memory sub-systems can be used in client systems that have relatively light workloads and are not subjected to extreme operating conditions. Other memory sub-systems, however, are intended for mobile applications, or enterprise datacenters, and are likely to face heavier workloads and potentially extreme operating conditions. These different customers and different uses cases may prioritize different features and property and capability characteristics of the memory sub-systems. Accordingly, the memory devices developed for these memory sub-systems, even if based on the same underlying technology, may need to meet different standards for various property and capability characteristics. Certain property and capability characteristics which may be of varying importance include reliability, write performance, data retention, read disturb effect, latent read disturb effect, endurance, or others. In general, however, the majority of these property and capability characteristics can be represented by the read window budget (RWB) present in a given memory device. The read window budget is associated with the read window size (i.e., a size measured in volts, representing the distance, on a voltage scale, between a threshold voltage distribution of memory cells associated with one programming level and a threshold voltage distribution of memory cells associated with a subsequent programming level) on the memory device. The read window budget refers to the cumulative value of the read windows (i.e., the total size of all the read windows of a set of memory cells), and generally is proportional to the property and capability characteristics of the memory device, such that a larger read window budget is indicative of the memory device's ability to satisfy stricter requirements for the various property and capability characteristics described above.

A certain type of memory device, for example, can include an array of memory cells configured as triple-level cell (TLC) memory (i.e., each cell is configured to store three bits of information). In other examples, the memory cells can be configured as other types of memory, such as single-level cell (SLC) memory, multi-level cell (MLC) memory, quad-level cell (QLC) memory, penta-level cell (PLC) memory, etc. During the manufacturing process, certain memory devices, especially those formed with a higher number of bits per cell, are susceptible to intrinsic variations that may lead to inconsistent operation. As a result, certain issues may arise during operation of the memory device, such as degraded read disturb effects, degraded cycling, erase saturation, higher resistance, etc. These issues may be present throughout an entire memory device (i.e., memory die) or in only portions of the memory device (e.g., on specific wordlines) and may prevent the memory device from meeting the standards for various property and capability characteristics of certain products. Such memory devices may be classified as “weak” or as having “low endurance.” The conventional approach is to either discard such weak memory dies, which dramatically hurts the manufacturing yield, or to use these weak memory dies only in products that have more relaxed standards for the property and capability characteristics.

Aspects of the present disclosure address the above and other deficiencies by enabling weak memory dies to meet product requirements in a memory sub-system. In one embodiment, the memory sub-system controller can use separate write cursors for host write operations and media management write operations in order to manage the write workload on weak memory dies in the memory sub-system. For example, the memory sub-system controller may allow host write operations to be performed on any memory die without restriction so as not to impact the quality of service seen by the host system, but may prevent certain media management write operations (e.g., garbage collection write operations) from being performed on the weak memory dies in order to extend the lifetime of those dies. In another embodiment, the memory sub-system controller may identify and/or track specific weak wordlines within a given memory die and prevent certain pages of data from being written to those wordlines. For example, in a memory device configured as TLC memory, normally each wordline may be programmed with three pages of data (e.g., a lower page, an upper page, and an extra page). For those specific wordlines that are weak or have lower endurance, the memory sub-system controller may prevent the extra page, for example, from being programmed with host data in order to ensure that the standards for the property and capability characteristics are met.

Advantages of the approach described herein include, but are not limited to, improved property and capability characteristics in the memory sub-system. For example, the negative impact from weak dies on host write performance can be reduced or eliminated and such weak dies can be used in products that have higher standards for the property and capability characteristics (e.g., endurance). In addition, when only certain data pages are impacted in a memory device, the overall endurance requirements can still be satisfied by excluding those pages from storing host data. As a result, manufacturing yield is increased and more memory dies are available for products with varying requirements.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., one or more memory device(s) 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL bus). The physical host interface provides an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, memory sub-system 110 includes write operation manager 113. In some embodiments, the memory sub-system controller 115 includes at least a portion of the write operation manager 113. In some embodiments, the write operation manager 113 is part of the host system 120, an application, or an operating system. In other embodiments, local media controller 135 includes at least a portion of write operation manager 113 and is configured to perform the functionality described herein. Write operation manager 113 can control write operations performed to the memory dies, such as memory device 130, within memory sub-system 110. In one embodiment, write operation manager 113 can use separate write cursors for host write operations and media management write operations in order to manage the write workload on a weak memory die in the memory sub-system 110. For example, write operation manager 113 may allow host write operations to be performed on any memory die without restriction, but may prevent media management write operations (e.g., garbage collection write operations) from being performed on the weak memory die, such as memory device 130, in order to extend the lifetime of those dies. In addition, write operation manager 113 may identify and/or track specific weak wordlines within a given memory die, such as memory device 130, and prevent certain pages of data from being written to those wordlines. Further details with regard to the operations of write operation manager 113 are described below.

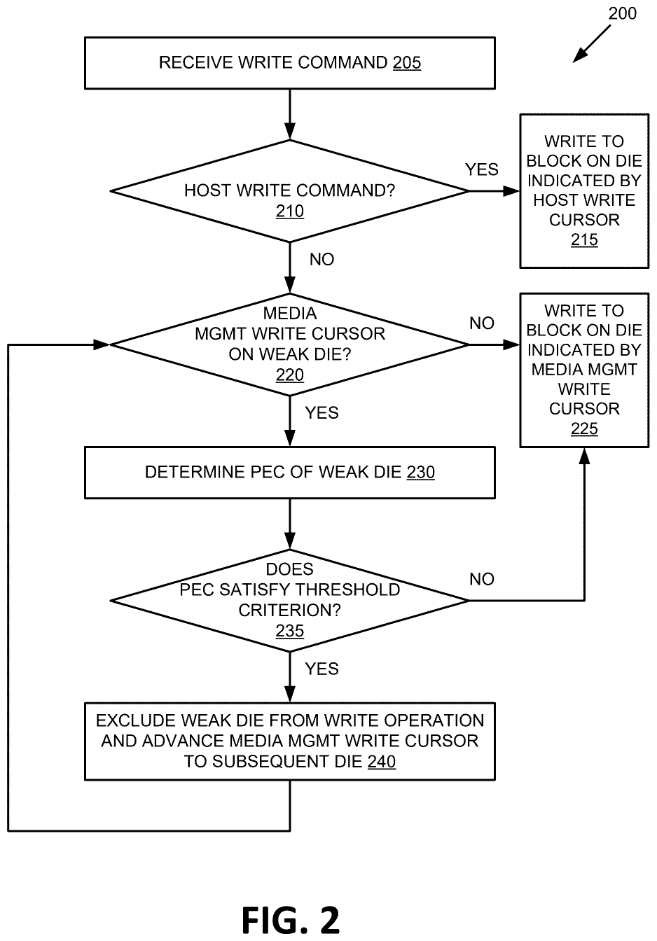

FIG. 2 is a flow diagram of an example method of enabling weak memory dies to meet product requirements in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by write operation manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In one embodiment, the processing logic (e.g., write operation manager 113 executed by memory sub-system controller 115) can initiate a plurality of write operations on a plurality of memory devices based on received write commands. As described in more detail below, the plurality of write operations may utilize a host write cursor and a separate media management write cursor to manage where the data is written on the memory devices, depending on the type of write operation being performed. During the write operations, the processing logic may permit the host write cursor to utilize segments on any of the plurality of memory devices including at least one memory device having the lower endurance characteristics (i.e., a weak memory die), while preventing the media management write cursor from utilizing the at least one memory device having the lower endurance characteristics for at least a subset of the plurality of write operations. Additional details are provided below.

At operation 205, the processing logic receives a write command and at operation 210 determines whether the received write command is a host write command or a media management write command. Host write commands can be received from host system 120, for example, and can include a request to write host data to a memory device in the memory sub-system 110. Media management write commands are scheduled internally within the memory sub-system 110 and may be part of a garbage collection operation, for example. In one embodiment, when a given segment of a memory device has both valid and invalid data, the valid data may be identified and rewritten to a new location so that the segment can be erased and reused. This write operation is one example of a media management write command. Other media management operations can generate media management write commands as well. The processing logic can determine whether the received write command is a host write command or a media management write command based on the source of the command and other metadata associated with the write command.

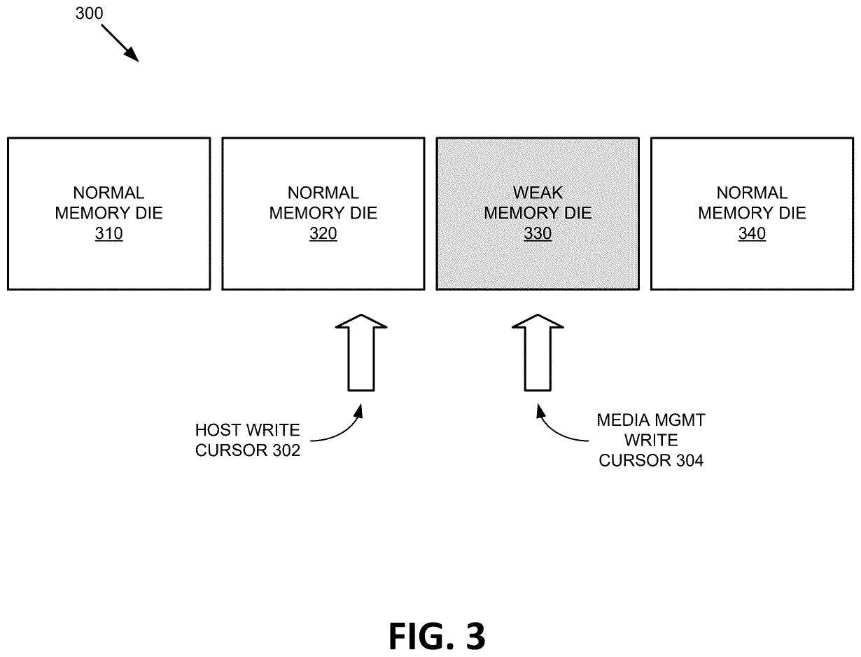

If the processing logic determines that the received write command is a host write command, at operation 215, the processing logic identifies a first segment on one of the plurality of memory devices to which a host write cursor is pointing and writes data associated with the host write command to the first segment. FIG. 3 includes a block diagram 300 illustrating a number of memory dies 310, 320, 330, 340 in a memory sub-system, such as memory sub-system 110. In one embodiment, at least one memory device (i.e., weak memory die 330) has lower endurance characteristics than a remainder of the plurality of memory devices (i.e., normal memory dies 310, 320, 340). The endurance characteristics can represent a number of program erase cycles (PECs) that the memory device can tolerate before failure, as well as potentially other property and capability characteristics, such as reliability, write performance, data retention, read disturb effect, latent read disturb effect, etc. The processing logic maintains a host write cursor 302 that indicates a segment of the memory devices where data associated with the next host write operation is to be written. As illustrated in diagram 300, the host write cursor 302 is currently pointing to a segment of normal memory die 320. Accordingly, the processing logic can write the data associated with the host write command to this segment. It can be noted, that for a host write command, the processing logic can write the associated data to any of the memory dies, even including weak memory die 330 if that memory die includes the segment to which the host write cursor 302 is currently pointing. The processing logic further maintains a media management write cursor 304 that indicates a potentially different segment of the memory devices where data associated with the next media management write operation is to be written.

Referring again to FIG. 2, if the processing logic determines that the received write command is not a host write command (i.e., is a media management write command), at operation 220, the processing logic identifies a second segment on one of the plurality of memory devices to which the media management write cursor 304 is pointing and determines whether the second segment is on the at least one memory device having the lower endurance characteristics (i.e., weak memory die 330). For example, if the media management write cursor 304 were pointing to a segment on one of normal memory dies 310, 320, 340, then at operation 225, the processing logic can write the data associated with the write command to the second segment. If, however, the media management write cursor 304 is pointing to a segment on weak memory die 330, as illustrated in FIG. 3, the processing logic can proceed to operation 230.

At operation 230, the processing logic determines a program erase cycle count of the at least one memory device having the lower endurance characteristics (i.e., weak die 330). In one embodiment, the memory sub-system maintains individual counters for each memory die to track the number of program erase cycles that have been performed thereon. The respective counter can be incremented after each program erase cycle is performed.

At operation 235, the processing logic determines whether the program erase cycle count satisfies a threshold criterion. In one embodiment, the processing logic compares the program erase cycle count (i.e., the value of the corresponding counter) to a predefined threshold value. If the program erase cycle count is less than the threshold value, the processing logic can determine that the threshold criterion is not satisfied. Conversely, if the program erase cycle count is greater than or equal to the threshold value, the processing logic can determine that the threshold criterion is satisfied.

Responsive to determining that the program erase cycle count does not satisfy the threshold criterion, at operation 225, the processing logic can write data associated with the media management write command to the second segment indicated by the media management write cursor 304. This includes the situation where the media management write cursor 304 is pointing to a segment on weak memory die 330, but the PEC count is deemed low enough that the media management write operation can be performed without risk of hurting the endurance of the at least one memory device.

Responsive to determining that the program erase cycle count satisfies the threshold criterion, however, at operation 240, the processing logic excludes the weak memory die 330 from the write operation and advances the media management write cursor 304 to a third segment on one of the remainder of the plurality of memory devices. Processing can return to operation 220, and depending on the result of the determinations, the processing logic can write data associated with the media management write command to the third segment. For example, the media management write cursor 304 may be advance to a segment on normal memory die 340 and the processing logic can write the data associated with the media management write operation to that segment.

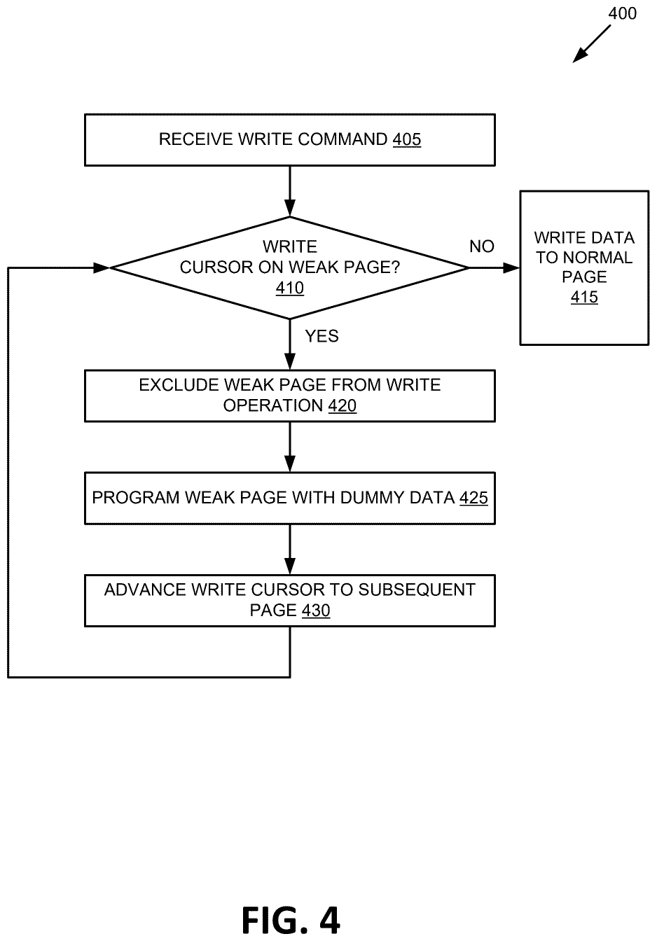

FIG. 4 is a flow diagram of an example method of enabling a memory die with weak pages to meet product requirements in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by write operation manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

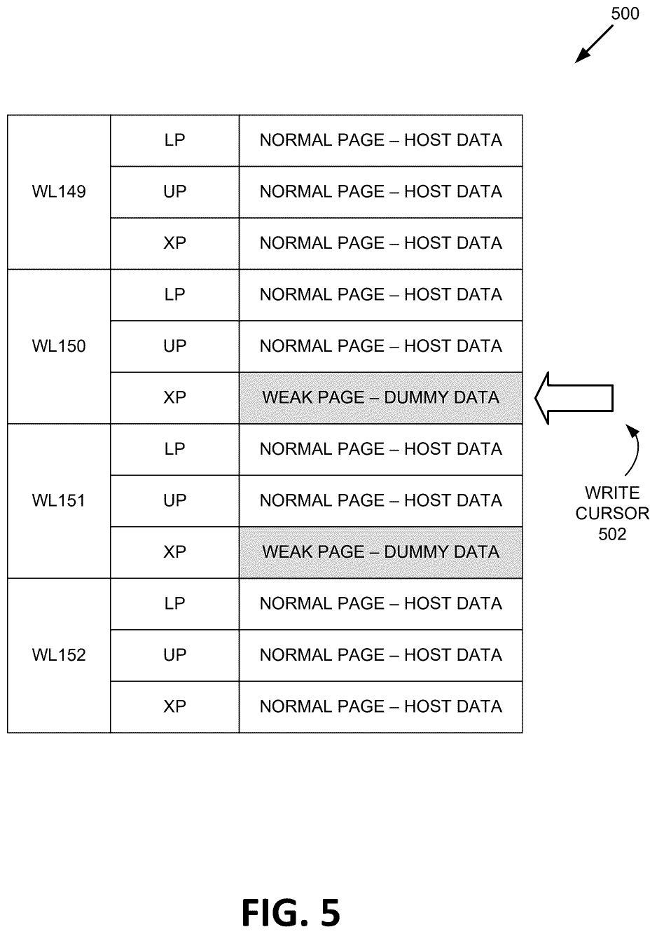

In one embodiment, the processing logic (e.g., write operation manager 113 executed by memory sub-system controller 115) can initiate a plurality of write operations on a memory device based on received write commands. As described in more detail below the memory device has plurality of wordlines including at least one wordline having lower endurance characteristics than a remainder of the plurality of wordlines. Furthermore, each of the plurality of wordlines has associated memory cells to store a plurality of pages of data. This is illustrated in chart 500 of FIG. 5, which depicts a number of wordlines (i.e., WL149, WL150, WL151, WL152) having memory cells configured as TLC memory. Thus, each wordline is configured to store three pages of data (i.e., a lower page (LP), an upper page (UP), and an extra page (XP)). The processing logic may prevent the plurality of write operations from storing at least one of the plurality of pages of data on the memory cells associated with the at least one wordline having the lower endurance characteristics, while permitting the plurality of write operations to store pages of data on any of the remainder of the plurality of wordlines. For example, WL150 and WL151 may have lower endurance characteristics, thereby preventing the extra page from being utilized on those wordlines. Additional details are provided below.

Referring to FIG. 4, at operation 405, the processing logic receives a write command. The received write command can be, for example, either a host write command or a media management write command. Host write commands can be received from host system 120 and can include a request to write host data to a memory device in the memory sub-system 110. Media management write commands are scheduled internally within the memory sub-system 110 and may be part of a garbage collection operation, for example. Other media management operations can generate media management write commands as well.

At operation 410, the processing logic determines whether a write cursor is pointing to the at least one wordline having the lower endurance characteristics. For example, if the write cursor 502 were pointing to a normal page (i.e., a page that does not have low endurance characteristics), then at operation 415, the processing logic can write the data associated with the write command to that page. If, however, the write cursor 502 is pointing to a weak page (i.e., a page with lower endurance characteristics), such as the extra page of WL150 as illustrated in FIG. 5, the processing logic can proceed to operation 420.

At operation 420, the processing logic excludes the weak page from the write operation and at operation 425, programs at least one page of dummy data to the memory cells associated with the at least one wordline having the lower endurance characteristics. For example, rather than programming the host data associated with the write operation to the extra page of WL150, the processing logic can instead program the dummy data to the extra page of WL150. The dummy data can vary depending on the embodiment, but can include, for example, a random data pattern, a pseudo-random data pattern, a predetermined data pattern, or other data pattern. The lower page and upper page of WL150 can still be programmed with normal host data.

At operation 430, the processing logic advances the write cursor to a subsequent page. For example, the write cursor 502 can be advance to the lower page of WL151 and the host data associated with the write operation can be written there. In addition, the processing logic can exclude the at least one page of dummy data from subsequent media management operations. Since the dummy data is programmed to the weak page, it cannot be used in the various different types of media management operations which are performed in the normal course of operation of the memory sub-system 110. For example, if there is XOR parity information (e.g., a redundant array of independent NAND (RAIN) stripe) used to reconstruct lost data, the dummy data can be excluded from the parity calculations. Similarly, when conducting a read disturb scan or a media scan, the processing logic can exclude the dummy data. Also, for block family error avoidance binning operations, the dummy data can be excluded. There may be certain media management operations that do take into account the dummy data, such as NAND detection of empty pages (NDEP) operations, however this is an exception.

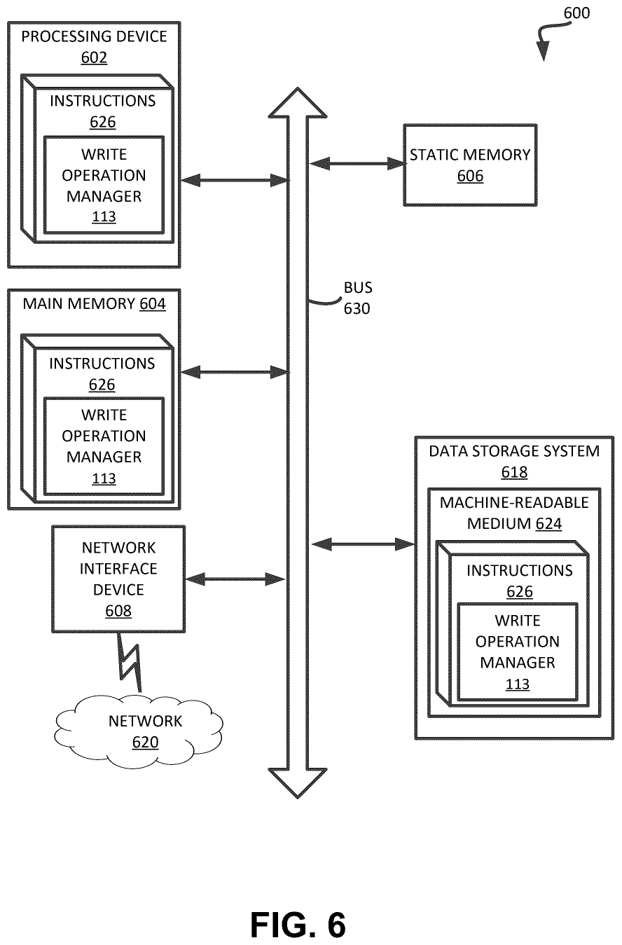

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1 and configured to perform operations corresponding to write operation manager 113) that includes, is coupled to, or utilizes a memory sub-system (e.g., the memory sub-system 110 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to the write operation manager 113 of FIG. 1. While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a plurality of memory devices, the plurality of memory devices including at least one memory device having lower endurance characteristics than a remainder of the plurality of memory devices; and
a processing device, operatively coupled with the plurality of memory devices, to perform operations comprising:
initiating a plurality of write operations on the plurality of memory devices based on received write commands, the plurality of write operations utilizing a host write cursor and a media management write cursor;
permitting the host write cursor to utilize segments on any of the plurality of memory devices including the at least one memory device having the lower endurance characteristics; and
preventing the media management write cursor from utilizing the at least one memory device having the lower endurance characteristics for at least a subset of the plurality of write operations.

2. The system of claim 1, wherein the processing device is to perform operations further comprising:
determining whether a received write command is a host write command or a media management write command.

3. The system of claim 2, wherein the processing device is to perform operations further comprising:
responsive to determining that the received write command is a host write command, identifying a first segment on one of the plurality of memory devices to which the host write cursor is pointing; and
writing data associated with the host write command to the first segment.

4. The system of claim 2, wherein the processing device is to perform operations further comprising:
responsive to determining that the received write command is a media management write command, identifying a second segment on one of the plurality of memory devices to which the media management write cursor is pointing; and
determining whether the second segment is on the at least one memory device having the lower endurance characteristics.

5. The system of claim 4, wherein the processing device is to perform operations further comprising:
responsive to determining that the second segment is not on the at least one memory device having the lower endurance characteristics, writing data associated with the media management write command to the second segment.

6. The system of claim 4, wherein the processing device is to perform operations further comprising:
responsive to determining that the second segment is on the at least one memory device having the lower endurance characteristics, determining a program erase cycle count of the at least one memory device having the lower endurance characteristics; and
determining whether the program erase cycle count satisfies a threshold criterion.

7. The system of claim 6, wherein the processing device is to perform operations further comprising:
responsive to determining that the program erase cycle count does not satisfy the threshold criterion, writing data associated with the media management write command to the second segment.

8. The system of claim 6, wherein the processing device is to perform operations further comprising:
responsive to determining that the program erase cycle count satisfies the threshold criterion, advancing the media management write cursor to a third segment on one of the remainder of the plurality of memory devices and writing data associated with the media management write command to the third segment.

9. A method comprising:
initiating a plurality of write operations on a plurality of memory devices based on received write commands, the plurality of memory devices including at least one memory device having lower endurance characteristics than a remainder of the plurality of memory devices, and the plurality of write operations utilizing a host write cursor and a media management write cursor;
permitting the host write cursor to utilize segments on any of the plurality of memory devices including the at least one memory device having the lower endurance characteristics; and
preventing the media management write cursor from utilizing the at least one memory device having the lower endurance characteristics for at least a subset of the plurality of write operations.

10. The method of claim 9, further comprising:
determining whether a received write command is a host write command or a media management write command.

11. The method of claim 10, further comprising:
responsive to determining that the received write command is a host write command, identifying a first segment on one of the plurality of memory devices to which the host write cursor is pointing; and
writing data associated with the host write command to the first segment.

12. The method of claim 10, further comprising:
responsive to determining that the received write command is a media management write command, identifying a second segment on one of the plurality of memory devices to which the media management write cursor is pointing; and
determining whether the second segment is on the at least one memory device having the lower endurance characteristics.

13. The method of claim 12, further comprising:
responsive to determining that the second segment is not on the at least one memory device having the lower endurance characteristics, writing data associated with the media management write command to the second segment.

14. The method of claim 12, further comprising:
responsive to determining that the second segment is on the at least one memory device having the lower endurance characteristics, determining a program erase cycle count of the at least one memory device having the lower endurance characteristics; and
determining whether the program erase cycle count satisfies a threshold criterion.

15. The method of claim 14, further comprising:
responsive to determining that the program erase cycle count does not satisfy the threshold criterion, writing data associated with the media management write command to the second segment.

16. The method of claim 14, further comprising:
responsive to determining that the program erase cycle count satisfies the threshold criterion, advancing the media management write cursor to a third segment on one of the remainder of the plurality of memory devices and writing data associated with the media management write command to the third segment.

17. A system comprising:
a memory device comprising a plurality of wordlines, the plurality of wordlines including at least one wordline having lower endurance characteristics than a remainder of the plurality of wordlines, each of the plurality of wordlines having associated memory cells to store a plurality of pages of data; and
a processing device, operatively coupled with the memory device, to perform operations comprising:
initiating a plurality of write operations on the memory device based on received write commands;
preventing the plurality of write operations from storing at least one of the plurality of pages of data on the memory cells associated with the at least one wordline having the lower endurance characteristics; and
permitting the plurality of write operations to store pages of data on any of the remainder of the plurality of wordlines.

18. The system of claim 17, wherein the processing device is to perform operations further comprising:
receiving a write command; and
determining whether a write cursor is pointing to the at least one wordline having the lower endurance characteristics.

19. The system of claim 18, wherein the processing device is to perform operations further comprising:
responsive to determining that the write cursor is not pointing to the at least one wordline having the lower endurance characteristics, writing the plurality of pages of data associated with the write command to the memory device.

20. The system of claim 19, wherein the processing device is to perform operations further comprising:
responsive to determining that the write cursor is pointing to the at least one wordline having the lower endurance characteristics:
programing at least one page of dummy data to the memory cells associated with the at least one wordline having the lower endurance characteristics; and
excluding the at least one page of dummy data from subsequent media management operations.
